(19) United States
(12) Patent Application Publication
(10) Pub. No.: US 2011/0120068 A1
(43) Pub. Date: May 26, 2011

(54) DILUTE PHASE ENTRAINMENT SUPPRESSION DEVICE

(76) Inventor: Jonathan A. Zenz, Poughkeepsie, NY (US)

(21) Appl. No.: 13/054,861

(22) PCT Filed: Jul. 21, 2009
(86) PCT No.: PCT/US09/51246

§ 371 Date: Jan. 19, 2011

(51) Int. Cl. B01D 45/16; B01D 45/08

(52) U.S. Cl. 55/461; 55/462

(57) ABSTRACT

A dilute phase entrainment suppression device is provided for reducing the amount of particulates from a gas stream above a fluidized bed of particulate. The apparatus reduces the particulate concentration in the gas stream by use of a low pressure drop device that operates at low gas velocities. On low temperature applications the unit could be mounted directly to the vessel wall, while for hot applications it would be supported from the cyclone system contained within the vessel.

### CROSS-REFERENCE TO RELATED APPLICATIONS

This application claims priority from U.S. Provisional Application Ser. No. 61/083,021 filed on Jul. 23, 2008, which is incorporated herein by reference in its entirety.

### BACKGROUND OF THE INVENTION

This invention relates to equipment for use in fluidized bed processes and more specifically to fluidized bed process vessels which use a variety of arrangements of cyclone and other dust separation equipment both internal and external to the process vessel, for example fluid catalytic cracking reactor and regenerator vessels and chemical fluidized bed reactors such as used in the reactors for production of vinyl chloride monomer and other chemical plants.

Fluidized bed processes generate or utilize particulate material that becomes entrained in the gas stream as it passes through and leaves the fluidized bed. This particulate material contributes to disadvantageous conditions such as air pollution, damage to equipment through which the gas passes, and the loss of expensive catalyst driving the fluidized process. For these reasons, it is desirable in a fluidized bed process to reduce the amount of entrained particulates in the gas stream leaving the fluidized bed.

In current practice, particle separation equipment may be located in a fluidized bed vessel above the dense phase of the fluidized bed in a region called the dilute phase. The gas stream containing the particulate material passes through the particle separation equipment where a portion of the particulates are separated from the gas. The particle separation equipment may alternatively be external to the vessel itself and the particulate-containing gas stream from the vessel is conveyed to it by conduit or other means. High solids loadings to the particulate separating equipment results in excessive particulate emission from the vessel and also leads to equipment wear.

Existing particle separation equipment in fluidized vessels take up a significant amount of internal space in the fluidized bed vessel leaving little room for mounting additional separating equipment. Also, many fluidized bed processes involve or generate significant amount of heat causing the vessel walls to undergo thermal expansion, making it difficult to stably mount equipment to the side walls of the vessel.

Accordingly, it is desirable to provide an apparatus that suppresses the entrainment of particles in the gas stream above a fluidized bed of particulate. It is further desirable to provide a particle entrainment suppression device so that loading of particulate material to subsequent separation equipment is minimized It is further desirable to provide a particle entrainment suppression device so that early and rapid separation of solids can be achieved over a fluidized bed process. It is further desirable to provide a particle entrainment suppression device that is readily mountable in the limited space available in the fluidized bed vessel to provide meaningful placement to permit a minimization of solids loading to the particle separation equipment utilized in the fluidized bed process.

### BRIEF SUMMARY OF THE INVENTION

There is, therefore, provided in the practice of the invention an apparatus for reducing the amount of particulates from a gas stream above a fluidized bed of particulate. Further, the apparatus can separate solids from the gas stream relatively rapidly and return them to the fluidized bed dense phase to help avoid loss of material. The apparatus can be positioned in the dilute phase of the fluidized bed but below the traditional particle separation equipment to reduce the particulate loading to the separation equipment. In this manner, an additional stage of cleaning can be made to the particulate-laden gas by pre-separating particulate and returning it to the fluidized bed before it ever reaches the inlet of the particle separation equipment.

In accordance with one embodiment, the invention consists of an array of tubes connected by a common plate baffle, the tubes being positioned to receive the gas stream from the fluidized bed. The individual tubes are open at both ends, with the bottom end configured with internally-disposed vanes formed in a radial pattern around a central support hub within the tube. The tube assembly is placed in the dilute phase portion of the fluidized bed below the upper limit of the transport disengaging height associated with the relevant fluidized process. The tubes are positioned in a cross-sectional plane of the fluidized bed vessel so as to be aligned with, and receive, the gas stream.

The tubes have a consistent diameter throughout their length to minimize pressure drop of gas flowing through the tube and also so that the gas velocity flowing through remains relatively constant. The vanes induce a spinning of the gas and solids entering the bottom of the tubes. Condensed solids separated from the spinning gas are deposited on the inner wall of the tubes which then fall by gravity back down to the fluidized bed. This effectively removes a substantial amount of particulate matter from the gas stream and decreases the load subjected on the downstream particle separation equipment.

Accordingly, it is an object of the present invention to reduce solids loading to the particle separation equipment by adding an additional stage of cleaning by pre-separating particulate by passing the particulate-laden gas through the low pressure drop subjected by the tubes of the device and returning the separated particles to the fluidized bed before they ever reach the inlet of the particle separation equipment. By reducing the particulate concentration entering the particle separation equipment, the inventive apparatus will provide benefits in the form of reduced overall particulate loss, recovery of high cost catalyst or marketable chemical product, and less burden on the equipment. By use of the inventive apparatus in the dilute phase of a fluidized bed as a pre-cleaner the particulate loading to particle separation equipment could be significantly reduced making the operation more economical. Furthermore, a significantly greater amount of solids can be separated from the gas stream and returned to the fluidized bed as soon as possible after optimum contact time with the gas stream has been achieved. This has significant benefit in processes relating to the gasification of biomass and coal.

Additionally, in applications where particle separation equipment is internally installed in the fluidized bed vessel the particulate concentration to the separation equipment influences the size of the equipment and can have significant impact on the equipment sizing and performance. The inventive apparatus can be mounted on existing bracing systems used to hold the particle separation equipment in place in the vessel, rather than mounted directly to the vessel walls, so that thermal expansion of the vessel walls will not adversely affect the apparatus. Alternatively, in fluidized bed processes where thermal expansion is not substantial, the apparatus can be mounted to the vessel walls.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE DRAWINGS

Further features of the present invention will become apparent to those skilled in the art to which the present invention relates from reading the following description with reference to the accompanying drawings, in which:

FIG. 1 is a view in side elevation schematically illustrating a fluidized bed vessel in which is placed the apparatus according to a preferred embodiment of the invention.

FIG. 2 is a cross-sectional top plan view taken along lines A-A of FIG. 1.

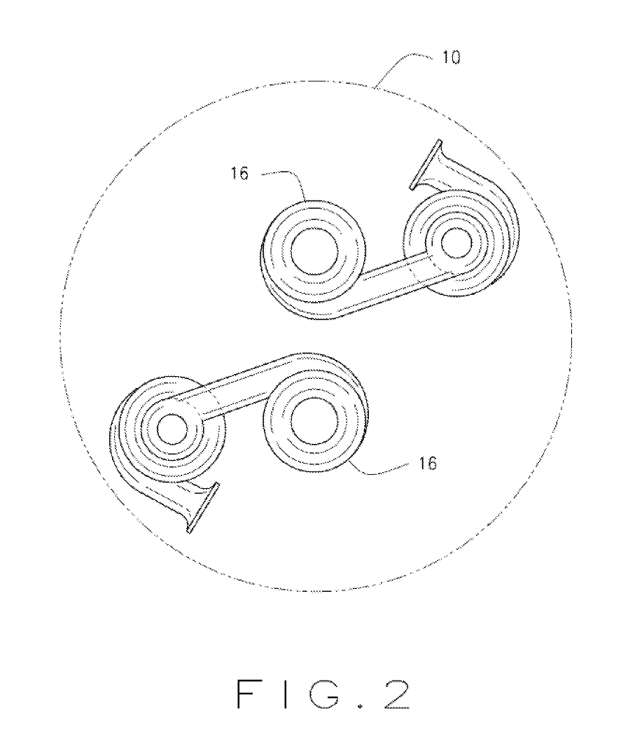

FIG. 3 is a cross-sectional top plan view taken along lines B-B in FIG. 1.

FIG. 4 is a cross-sectional view in side elevation taken along lines C-C of one of the tubes shown in FIG. 3.

### DETAILED DESCRIPTION OF THE INVENTION

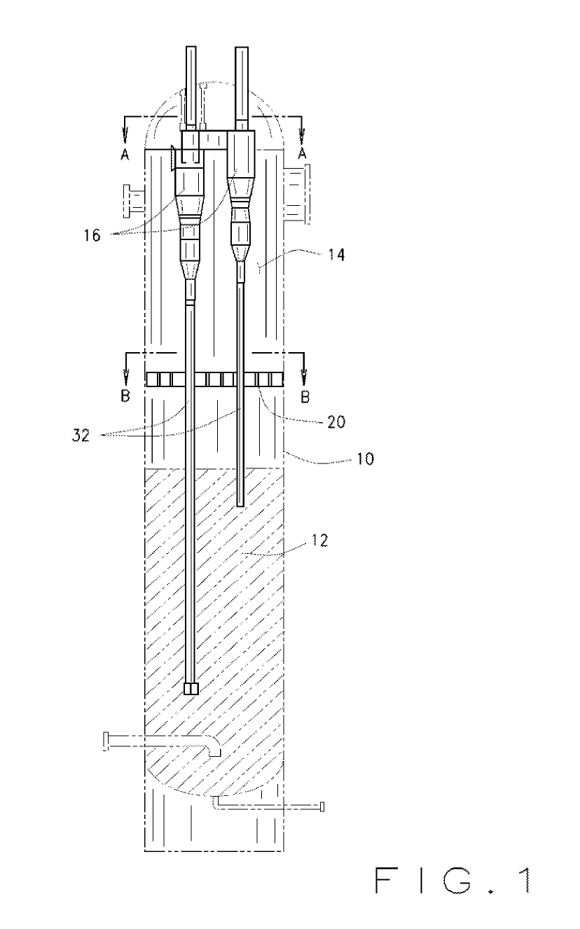

The invention will now be described with reference to the drawing figures, in which like reference numerals refer to like parts throughout. The apparatus of the instant invention is provided for reducing the amount of particulates from a gas stream above a fluidized bed of particulate. A schematic view of a fluidized bed vessel generally indicated by the reference numeral 10 is illustrated in FIG. 1 and is generally understood by those having skill in the art. The fluidized bed medium 12 comprises the solid particulate substance and other components, such as a catalytic cracking catalyst. Medium 12 represents the fluidized bed dense phase. As the gas stream flows through the dense phase 12, particulate matter (not shown) becomes entrained in the gas stream in the freeboard region 14 above the dense phase 12. This particulate-entrained gas stream is called the dilute phase of the fluidized bed. Particle separation equipment, such as cyclones 16, mounted in fluidized bed vessel 10 capture the gas/particulate stream as is well understood by those having skill in the art.

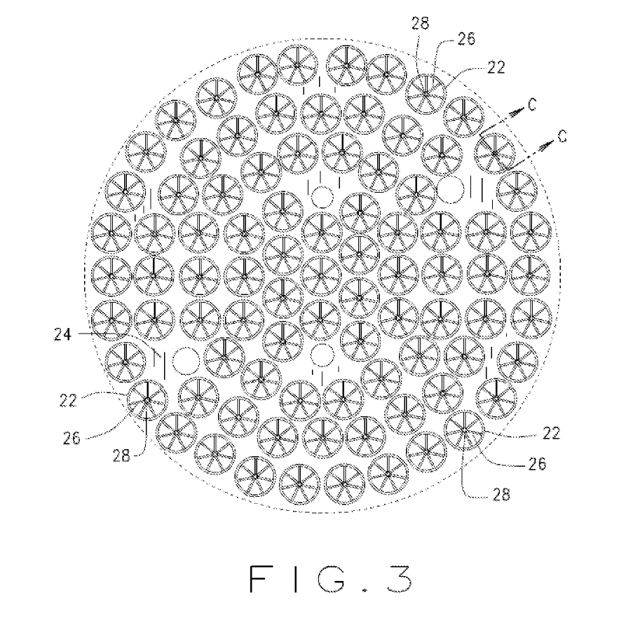

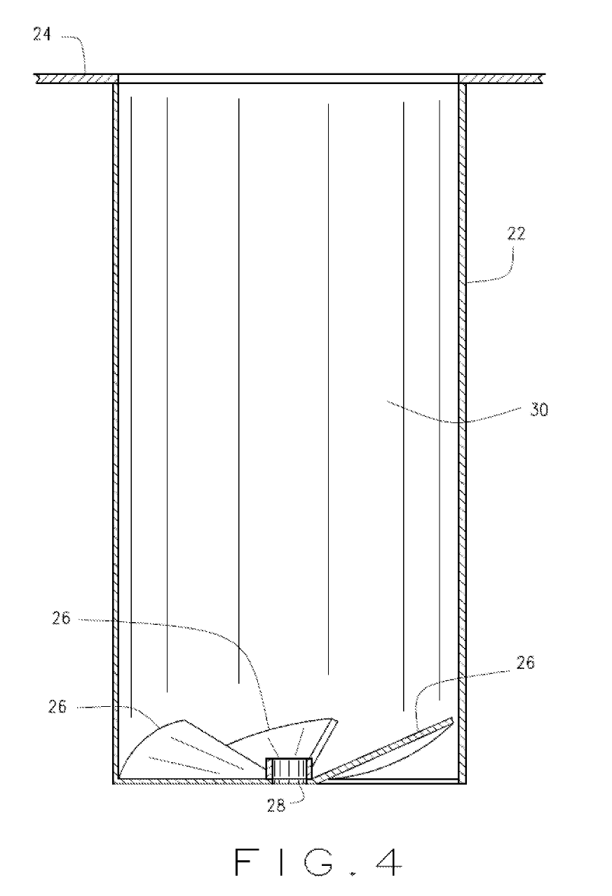

The particulate entrainment suppression device assembly of the present invention is generally indicated by reference numeral 20, and is mounted in vessel 10 as seen in FIG. 1. Assembly 20 comprises an array of tubes 22 mounted on a plate baffle 24 as shown in FIG. 3. Assembly 20 is mounted in vessel 10 so that tubes 22 run essentially collinearly with the general flow of the gas stream emanating from the fluidized bed. Each tube 22 comprises a cylinder of essentially consistent diameter along its length as shown in FIG. 4. Having a consistent dimensioned diameter through the cylinder ensures that the gas stream passing through the tube experiences minimal pressure drop and consistent gas velocity. A plurality of radial vanes 26 are provided at the bottom open end of each tube 22. Vanes 26 effect a spinning motion to the gas stream as it enters tube 22. The outer radial ends of vanes 26 connect to the inner wall of tube 22. Vanes 26 anchor to central hub 28, which inhibits gas flow through the center of the tubes and directs the spinning gas flow towards the inner side wall 30 within tube 22. Seven vanes impart a satisfactory spinning action to the gas, but the number of vanes used can vary.

The diameter of tubes 22 can vary depending upon the capacity of the fluidized bed and gas velocity, and can be between four inches to eighteen inches. As shown in FIG. 3, the number and placement of tubes 22 in assembly 20 should be such that the maximum cross-sectional area of the fluidized bed vessel is covered. Preferably, for low gas velocity ranges below three feet per second, a six inch diameter tube is preferred, but may be between four to twelve inches in diameter. For gas velocities in the range of three to five feet per second a sixteen inch diameter tube is preferred, but may be between fourteen to eighteen inches in diameter. The length of tube 22 should be at least equal to its diameter, but the length of the tube need not be greater than one and a half times the diameter of the tube. Vanes 26 are preferably disposed in the bottom end of tube 22 to have a forty degree)(40°) incline from their horizontal plane with the opening of the tube. Where the gas velocity is greater than three feet per second the vane angle may be set with a higher degree angle, preferably forty-five degrees)(45°).

The gas and solids leaving the dense phase 12 of the fluidized bed or other process enter tubes 22 from the underside and come into contact with vanes 26. The vanes impart on the gas and solids a spiral flow pattern. The solids, being heavier than the gas carrying them, move outward due to centrifugal force to the wall 30 of each tube 22 where they concentrate. The solids then climb vertically upward in a spiral pattern until their kinetic energy has been dissipated to the extent that the solid material begins to flow vertically downward in a spiral pattern. This pattern continues until the stream of solids impacts the top side of one of the vanes 26 at which point it will change directions and flow out of tube 22 along the top surface of the vane. The gas exits through the top of tube assembly 20 along with any solid particulate that did not get captured in the tubes and returned to the dense phase 12 below the particulate entrainment suppression device.

Baffle plate 24 of the particulate entrainment suppression assembly 20 may be vented to permit gas flow through the spaces between adjacent tubes, and an airtight seal to the interior of the fluidized bed vessel wall is not necessary. The internal cyclones systems in fluidized bed applications typically have bracing pipes oriented in a horizontal array connecting the diplegs 32 of the cyclones 16 together. The support for the assembly 20 can therefore be one of the horizontal bracing levels as shown in FIG. 1. This mounting arrangement permits a gap between assembly 20 and the vessel wall to accommodate thermal growth difference for hot processes that utilize cold wall (internally insulated) vessels. In low temperature applications where thermal expansion is not substantial, assembly 20 may alternatively be mounted directly to the fluidized bed vessel wall. For example, a ring support mounted to the vessel wall may be used for moderate temperatures only. When assembly 20 is mounted directly to the vessel wall, venting passageways should be provided for the gas stream to partially vent around assembly 20.

Tubes 22, being of constant diameter through their entire length, subject the gas stream to minimal pressure drop as it passes through assembly 20 and therefore avoids disruption to the underlying fluidized process. The invention also provides the great flexibility by being able to be located anywhere in the dilute phase of the fluidized bed. The device may be placed at the transport disengaging height in the dilute phase, or at any level above or below the transport disengaging height in the dilute phase. Using the cyclone dipleg bracing as a means of support eliminates the need to support the device from the vessel. In addition, by being capable of being supported from the cyclone system rather than the vessel wall, the device avoids stresses due to thermal expansion differences between the device and the vessel. This becomes of even more importance when the vessel is internally insulated to keep the pressure shell colder than the internal process temperature. Further, by being positioned in the dilute phase of the fluidized bed, there is no impact on the bed reaction as might occur with a device placed in the dense phase.

Accordingly, the entrainment suppression device is provided for reducing the amount of particulates from a gas stream in the dilute phase above a fluidized bed of particulate. The apparatus is particularly useful in reducing the catalyst solids loading to a cyclone system in a fluid bed application such as chemical fluidized bed reactors and fluid catalytic cracking reactors and regenerators. The apparatus effectively reduces the particulate concentration in the gas stream by use of a low pressure drop device that operates at low gas velocities while accommodating thermal growth by means of the support method utilized.

Although an example of the particulate entrainment suppression device is shown, it will be appreciated that other embodiments can be employed. Also, although the particulate entrainment suppression device is useful to reduce particulate loading to fluidized bed particle separation equipment it can also be used in other related applications. From the above description of preferred embodiments of the invention, those skilled in the art will perceive improvements, changes and modifications. Such improvements, changes and modifications within the skill of the art are intended to be covered by the present invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A particle entrainment suppression apparatus for separating particulate material from a gas stream, the apparatus comprising a baffle member having a plurality of passage members, the passage members each comprising an extended passageway, the passage members being disposed in the baffle member such that the passageways through the passage members are oriented transversely to the baffle member for receiving the gas stream whereby particulate matter is separated from the gas stream as it flows through the passage members.

2. The particle entrainment suppression apparatus of claim 1 in which the passage members comprise cylindrical tube members.

3. The particle entrainment suppression apparatus of claim 2 in which a diameter of each tube member is constant along its length.

4. The particle entrainment suppression apparatus of claim 2 in which vane members are disposed in each of the tube members, whereby the gas stream entering the particle entrainment separation apparatus contacts the vane members.

5. The particle entrainment suppression apparatus of claim 4 in which the vane members are connected to a central hub member and are radially disposed in a leading end of the tube members to induce a spinning motion to the gas stream entering the leading end of the tube members whereby particulate matter is caused to separate from the gas stream by centrifugal force.

6. The particle entrainment suppression apparatus of claim 5 in which the vane members are disposed with an incline between forty degrees)(40°) to forty-five degrees)(45°) from their horizontal plane with the opening of the leading end of the tube members.

7. The particle entrainment suppression apparatus of claim 1 in which a length of a passage member is no less than its diameter.

8. The particle entrainment suppression apparatus of claim 1 in which a length of a passage member is a value representing a range of between one to one and a half times its diameter.

9. The particle entrainment suppression apparatus of claim 1 in which the passage members have a diameter of between four to eighteen inches.

10. In a fluidized bed process vessel equipped with cyclone separation equipment for separating particulate matter from a gas stream, the improvement comprising a particle entrainment suppression apparatus comprising a baffle member disposed in the vessel such that the baffle member receives the gas stream in advance of the gas stream entering the cyclone separation equipment, the baffle member having a plurality of passage members, the passage members each comprising an extended passageway, the passage members being disposed in the baffle member such that the passageways through the passage members are oriented transversely to the baffle member for receiving the gas stream whereby particulate matter is separated from the gas stream as it flows through the passage members.

11. The particle entrainment suppression apparatus of claim 10 in which the passage members comprise cylindrical tube members.

12. The particle entrainment suppression apparatus of claim 11 in which a diameter of each tube member is constant along its length.

13. The particle entrainment suppression apparatus of claim 11 in which vane members are connected to a central hub member and are disposed in a leading end of each of the tube members, whereby the gas stream entering the particle entrainment separation apparatus contacts the vane members, the vane members being radially disposed to induce a spinning motion to the gas stream entering the tube members.

14. The particle entrainment suppression apparatus of claim 13 in which the vane members are disposed with an incline between forty degrees)(40°) to forty-five degrees)(45°) from their horizontal plane with the opening of the leading end of the tube members.

15. The particle entrainment suppression apparatus of claim 10 in which a length of a passage member is no less than its diameter.

16. The particle entrainment suppression apparatus of claim 10 in which a length of a passage member is a value representing a range of between one to one and a half times its diameter.

17. The particle entrainment suppression apparatus of claim 10 in which the passage members have a diameter of between four to eighteen inches.

18. The particle entrainment suppression apparatus of claim 10 in which the baffle member is mounted to the interior wall of the fluidized bed process vessel.

19. The particle entrainment suppression apparatus of claim 10 in which the baffle member is independently mounted apart from the interior wall of the fluidized bed process vessel to avoid disruption caused by thermal expansion of the interior wall.
